(19) United States
(12) Patent Application Publication
(10) Pub. No.: US 2026/0123812 A1
(43) Pub. Date: May 7, 2026

(54) MODULAR SPRAY MOP WITH SPRAY BOTTLE

(71) Applicant: Jay K. Sim, Irvine, CA (US)

(72) Inventor: Jay K. Sim, Irvine, CA (US)

(21) Appl. No.: 19/378,051

(22) Filed: Nov. 3, 2025

Related U.S. Application Data
(60) Provisional application No. 63/715,801, filed on Nov. 4, 2024.

(51) Int. Cl. A47L 13/22; A47L 13/42; A47L 13/50; B05B 11/10; B05B 15/62; B65D 1/02; B65D 83/76

(52) U.S. Cl. CPC A47L 13/22; A47L 13/42; A47L 13/50; B05B 11/1042; B05B 15/62; B65D 1/0246; B65D 83/76

(57) ABSTRACT

A cleaning system has an elongate handle member extending from a top handle to a cleaning implement, and a housing formed on the elongate handle member between the top handle and the cleaning implement. The housing includes a bottle cavity having a connecting surface for engaging a spray bottle, and a detachment mechanism for disengaging the connecting surface from the spray bottle, enabling the spray bottle to be used independently as a handheld sprayer. The spray bottle has a liquid storage compartment, a spray pump mechanism, and a valve for transferring liquid from the liquid storage compartment to the cleaning implement.

### CROSS-REFERENCE TO RELATED APPLICATIONS

This application for a utility patent claims the benefit of U.S. Provisional Application No. 63/715,801, filed Nov. 4, 2024.

### BACKGROUND OF THE INVENTION

### Field of the Invention

This invention relates generally to surface cleaning devices, and more particularly to a modular spray mop system that utilizes a detachable spray bottle.

### Description of Related Art

Conventional spray mops, such as those marketed by BONA® and similar systems, employ a liquid reservoir mounted on the handle for supplying fluid to a cleaning head of the mop. While the liquid reservoir is functional for standard mop use, such reservoirs don't include a spray mechanism that enable them to be easily removed for separate use as handheld sprayers. Consequently, users must maintain a separate cleaning product for spraying on other surfaces, such as tables and counter tops.

There exists a need for a cleaning system that provides a bottle having a pump spray mechanism on a reservoir of liquid, so that the detachable reservoir may be used independently as a spray cleaner, for cleaning, for example, kitchen counters, tables, etc. There is also a need for such as mop that includes an automatic sealing valve to prevent leakage during detachment, and re-establishes fluid communication automatically when reattached to the mop. Such a combination enables a user to quickly and easily detach, use, and re-attach the spray cleaner, so that a used does not have to carry a separate cleaning sprayer. The present invention fulfills these needs and provides further advantages as described in the following summary.

### SUMMARY OF THE INVENTION

The present invention teaches certain benefits in construction and use which give rise to the objectives described below.

The present invention provides a cleaning system comprising an elongate handle member extending from a top handle to a cleaning implement, and a housing formed on the elongate handle member between the top handle and the cleaning implement. The housing includes a bottle cavity having a connecting surface for engaging a spray bottle, and a detachment mechanism for disengaging the connecting surface from the spray bottle, enabling the spray bottle to be used independently as a handheld sprayer. The spray bottle comprises a liquid storage compartment, a spray pump mechanism, and a valve for transferring liquid from the liquid storage compartment to the cleaning implement.

A primary objective of the present invention is to provide a cleaning system having advantages not taught by the prior art.

Another objective is to provide a cleaning system that includes a bottle of cleaning fluid having a pump spray mechanism, so that the detachable bottle may be used independently as a spray cleaner

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a cleaning system according to one embodiment of the present invention;

FIG. 2 is a side elevation sectional view of a spray bottle of the cleaning system;

FIG. 3 is a top perspective view of a bottom portion of the spray bottle;

FIG. 4 is a bottom perspective view of the bottom portion of the spray bottle;

FIG. 5 illustrates a refill cartridge being inserted into the spray bottle;

FIG. 6 is an up-close perspective view of a housing of the cleaning system;

FIG. 7 is a perspective view thereof, showing a nozzle cover of the housing in an open configuration;

FIG. 8 is an exploded perspective view thereof;

FIG. 9 is an up-close sectional view of a release mechanism of the housing;

FIG. 10 is an up-close sectional view of a valve of the spray bottle;

FIG. 11 is a block diagram illustrating a pump system of the cleaning system;

FIG. 12 is a perspective view of a locking mechanism according to one embodiment of the present invention and showing the locking mechanism in a locked position; and

FIG. 13 is a side elevation view thereof, showing the locking mechanism in an unlocked position to allow the spray bottle to be removed from the housing.

### DETAILED DESCRIPTION OF THE INVENTION

The above-described drawing figures illustrate the invention, a cleaning system for cleaning surfaces having a detachable spray bottle that functions both as a liquid reservoir for a mop and as an independent handheld sprayer.

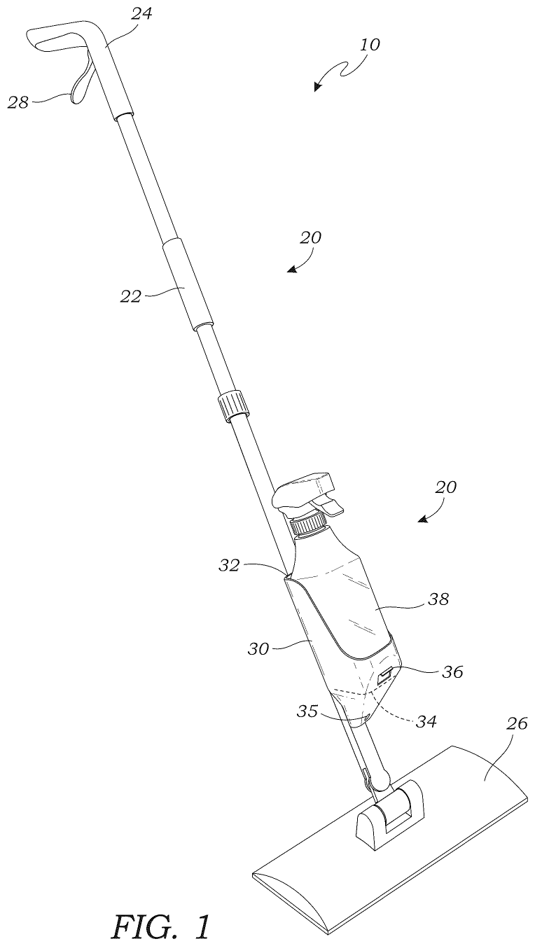

FIG. 1 is a perspective view of a cleaning system 10 according to one embodiment of the present invention. As shown in FIG. 1, the cleaning system 10 comprises a mop 20 and a detachable spray bottle 40, each described in detail below. The combination mop with spray bottle 10 is adapted to contain a liquid cleaning product 38 in the spray bottle 40, and this liquid cleaning product 38 may be sprayed from the mop 20 for cleaning the floor with the mop 20, and wherein the spray bottle 40 may also be detached and used separately from the mop 20, for spraying tables surfaces and other cleaning work, as discussed further below.

For the purposes of this application, the term “liquid cleaning product” is hereby defined to encompass any form of liquid cleaner, including, but not limited to all-purpose cleaners, liquid soaps, disinfectants, de-fogging formulas, polishes, etc., or any other form of liquid that a user desires to dispense onto a surface such as a floor, wall, countertop, window/mirror, etc., or similar surfaces.

In the illustrated embodiment, the mop 20 comprises an elongate handle member 22 that extends from a top handle 24 to a cleaning implement 26 such as a cleaning pad, although other cleaning implements may be used, such as a sponge or bundle of strings, or any other wet cleaning tool known in the art. Since this type of cleaning pad is well-known in the art, it is not discussed further herein. The top handle 24 of the mop 20 may include any features typical of similar handles, and in this embodiment further includes a trigger 28 for spraying cleaning product 38 out of the cleaning implement 26 or the housing 30, discussed further below. As shown in FIG. 1, in some embodiments, an outlet 35 is mounted on the housing 30, for spraying from the housing 30.

As shown in FIG. 1, a housing 30 is formed on the elongate handle member 22 between the top handle 24 and the cleaning implement 26. The housing 30 includes a bottle cavity 32 having a connecting surface 34 that engages the spray bottle 40, and a detachment mechanism 36 for disengaging the connecting surface 34 from the spray bottle 40, discussed in greater detail below. In some embodiments, the bottle cavity 32 further includes a rear cutout for allowing the it to be properly nested in the bottle cavity 32.

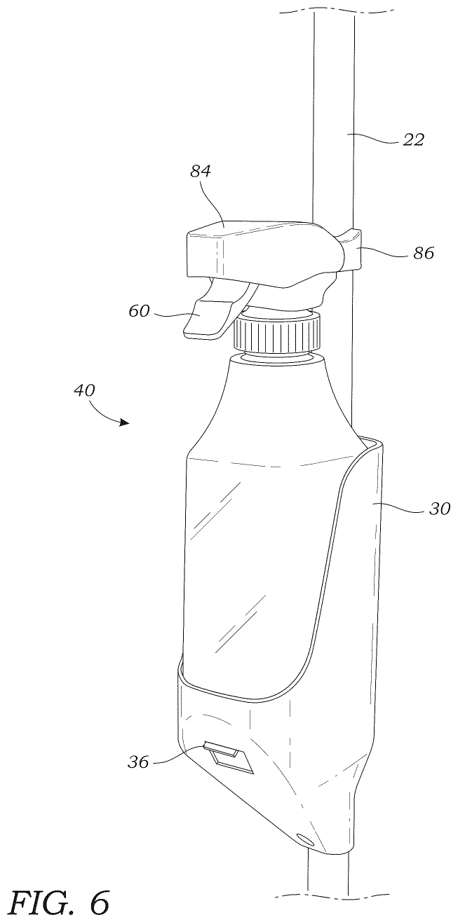

In this embodiment, the detachment mechanism 36 is in the form of a release lever formed on the housing 30, but in other embodiments the detachment mechanism 36 may be any suitable type of mechanism, e.g., a button, draw latch, clip, claw, hook and loop fastener, pin, strap, etc., on any part of the cleaning system 10. In one example (not shown), the spray bottle 40 may include a shroud that may be pulled upwardly to “pop” the spray bottle 40 out of the bottle cavity 32. Furthermore, in some embodiments, the spray bottle 40 may be frictionally or magnetically attached to the connecting surface 34, without the need for a separate detachment mechanism 36. In use, the detachment mechanism 36 allows for quick detachment, enabling users to easily clean various surfaces such as countertops, shelves, bookcases, TV stands, blinds, and other hard-to-reach areas that traditional mops cannot access. In this manner, the cleaning system 10 enables “vertical and horizontal” cleaning. In this manner, the cleaning fluid may be dispensed by either the spray bottle 40 or by the mop 20. The detachment mechanism 36 is best shown in FIGS. 6-9 and is discussed further below.

In various embodiments, the mop 20 may further include any features known in the art to enhance functionality or aesthetics, e.g., handle pads for gripping the elongate member, release mechanisms for separating the elongate member from the housing 30 or the cleaning implement 26, etc. In some embodiments (not shown), the cleaning system 10 includes an accessories pouch for storing cleaning tools such as washcloths, sponges, scrubbers, dusters, etc., especially for use with the spray bottle 40 when it is detached from the mop 20. The accessories pouch may alternatively be in the form of hook(s), clip(s), magnetic attachments for custom tools, etc.

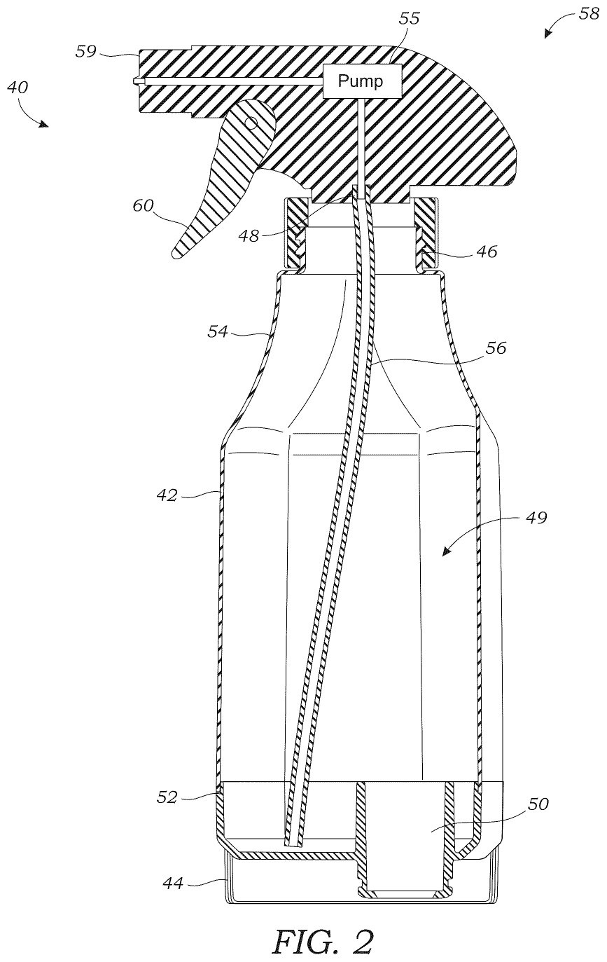

FIG. 2 is a side elevation sectional view of the spray bottle 40 of the cleaning system 10. As shown in FIG. 2, the spray bottle 40 comprises an upwardly extending sidewall 42 that extends upwardly from a base 44 to a neck 46 that defines a top opening 48, together forming a liquid storage compartment 49. The base 44 further includes a valve 50 that connects with the connecting surface 34 of the mop 20 for gradual transfer of the liquid cleaning product 38 from the liquid storage compartment 49 into the cleaning implement 26.

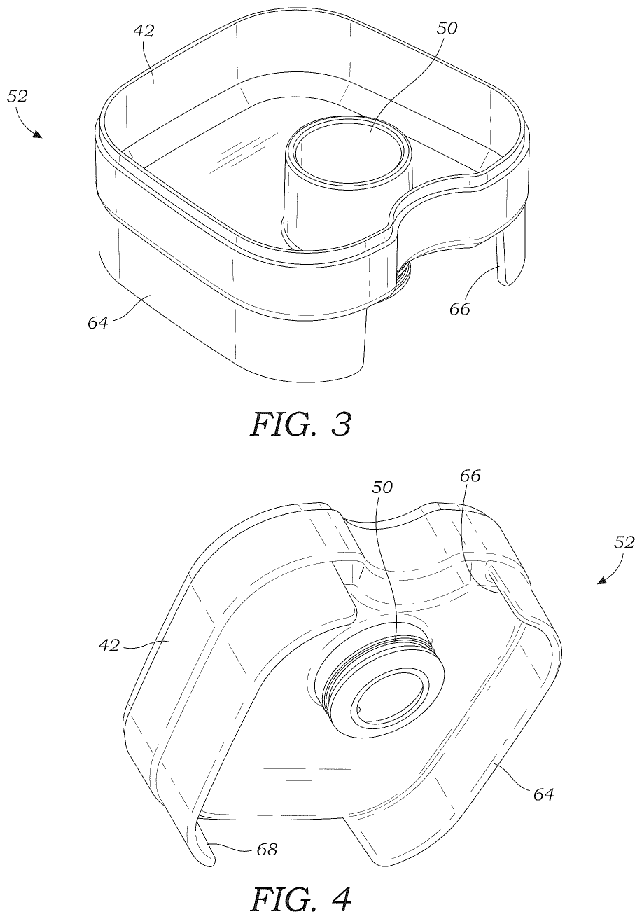

In some embodiments, the spray bottle 40 includes a bottom portion 52 and a top portion 54 that are initially manufactured (e.g., injection molded) separately, and then the two parts are then heat welded together. The bottom portion 52 may further be attached to the rest of the bottle via a different means, e.g., threads, a flange and groove, etc. The bottom portion 52 is best shown in FIGS. 3-4 and discussed in detail below.

As illustrated in FIG. 2, the neck 46 of the bottle may attach to a spray pump mechanism 58, which may be a threaded engagement, frictional engagement, bayonet, or any other type of removable attachment known in the art. The spray pump mechanism 58 may be operatively connected with an elongate stem tube 56 that extends through the top opening 48 and into the liquid storage compartment 49 when the spray pump mechanism 58 is mounted on the neck 46 of the bottle. The spray pump mechanism 58 may include a pump actuator lever 60 that is pivotally mounted by a pivot for actuating a pump 55 for spraying cleaning product out of a spray outlet 59.

FIG. 3 is a top perspective view of the bottom portion 52 of the spray bottle 40, and FIG. 4 is a bottom perspective view thereof. As shown in FIGS. 2-4, the bottom portion 52 includes the base 44 having the valve 50 formed therethrough, and a portion of the upwardly extending sidewall 42 for connection to the rest of the bottle. In some embodiments, the upwardly extending sidewall 42 includes an indentation (not shown), which may be useful for removing the spray bottle 40 from the bottle cavity 32 of the mop 20. The bottom portion 52 may further include a downwardly extending wall 64 that extends downwardly from the base 44 at least as far as the valve 50, wherein the downwardly extending wall 64 includes a front opening 66 and a back opening 68. In this embodiment, the valve 50 is generally tubular in construction and is adapted for engagement with the connecting surface 34 of the mop 20.

In use, the downwardly extending wall 64 engages with the connecting surface 34, wherein the detachment mechanism 36 releases the downwardly extending wall 64 from the receivers when pressed. In alternative versions, the base 44 may include other downwardly extending portions, in various configurations, or the connecting surface 34 may instead include protrusions that engage with receivers of the base 44. Further details of the connecting surface 34 and base 44 are discussed below.

In some embodiments, the spray bottle 40 is manufactured using injection molding. Traditionally, bottles are not made using injection molding, and are instead made through blow molding or extrusion processes. Traditional blow molding or extrusion processes only opens one side of the bottle, which is effective for creating hollow structures but limits the ability to add additional openings in the hollow structure. To add a valve or opening at the bottom, secondary operations such as drilling are required, which is inefficient, labor intensive, and can lead to leaking. Injection molding allows for highly precise designs that can include intricate features, such as the specialized valve. Unlike blow molding, which limits structural complexity, injection molding can accommodate multi-functional components and integrate these features without compromising the integrity of the bottle. This precision improves product functionality and reliability. Injection molding also produces bottles with uniform wall thickness and superior strength. This is critical for the design, where the bottle must support detachable functionality and withstand the repeated stresses of attaching and detaching, maintaining a leak-proof seal over time. With injection molding, the bottle and bottom portion/valve can be produced as separate components and later assembled seamlessly, avoiding tolerance issues common in cut-and-join methods. This streamlines manufacturing, reduces assembly time, and ensures compatibility between parts. Furthermore, injection molding offers flexibility in creating custom shapes and sizes. While injection molding offers distinct advantages for using Injection Molding, other methods, such as extrusion blow molding and traditional blow molding, may also be applied to achieve similar bottle forms and functionalities.

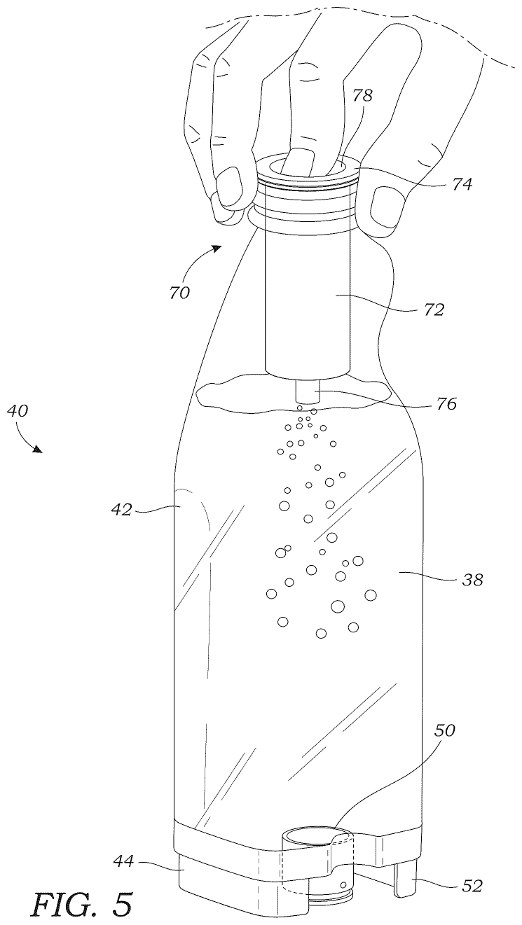

FIG. 5 illustrates a refill cartridge 70 being inserted into the spray bottle 40. As shown in FIG. 5, in some embodiments, the refill cartridge 70 may be inserted into the top opening 48 of the spray bottle 40 for injecting cleaning product into liquid (e.g., water) to create a liquid cleaning product 38. In this manner, the spray bottle 40 may be easily refilled without needing to pour an unwieldy liquid container into the liquid storage compartment 49 or replace the spray bottle 40 entirely. As shown in FIG. 5, the refill cartridge 70 comprises a tubular body 72 having a diameter that is less than the diameter of the top opening 48 of the spray bottle 40. The refill cartridge 70 further includes an upper flange 74 that is approximately equal in diameter to the top opening 48, which stops the tubular body 72 from falling entirely into the liquid storage compartment 49 when inserted through the top opening 48. The refill cartridge 70 may further include a bottom dispenser 76, and a dispensing plug 78 located on top of the tubular body 72.

In use, the liquid storage compartment 49 is first filled with water (or other liquid that is chemically compatible with the cleaning product within the refill cartridge 70), and then the tubular body 72 is inserted into the top opening 48 of the spray bottle 40, wherein the upper flange 74 suspends the tubular body 72 from the top opening 48. Next, the dispensing plug 78 is pressed or “clicked” as illustrated, which causes the cleaning product to dispense out of the bottom dispenser 76 and into the water, thereby forming the liquid cleaning product 38. The refill cartridge 70 may include a conduit (not shown) that allows the elongate stem tube 56 to pass therethrough and into the liquid storage compartment 49 for spraying. Once the cleaning product has been fully dispensed from the refill cartridge 70, it may be easily removed and replaced for further use.

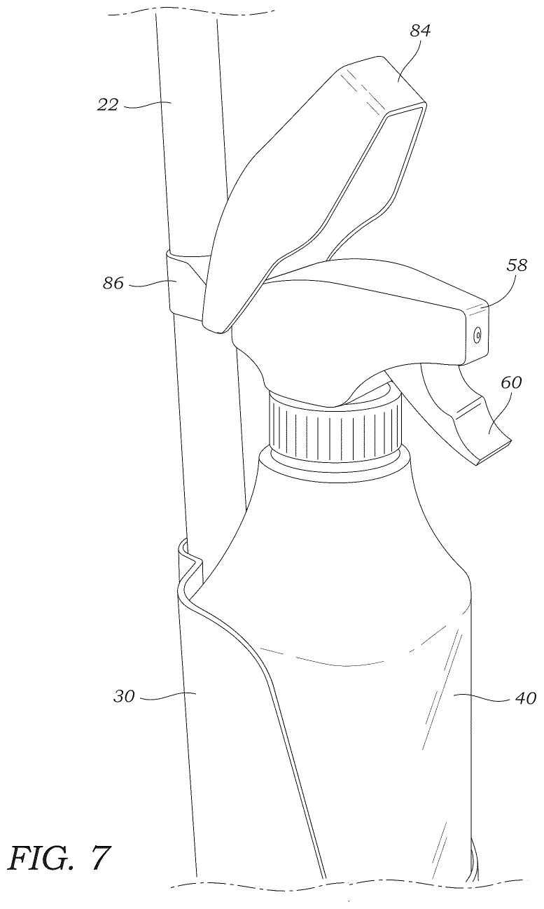

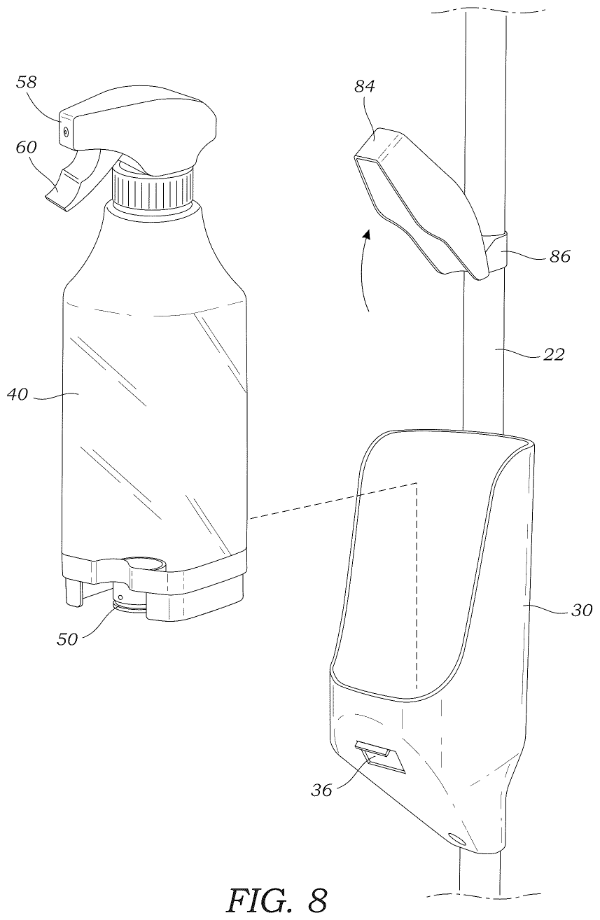

FIG. 6 is an up-close perspective view of the housing of the cleaning system 10, FIG. 7 is a perspective view thereof, showing a nozzle cover 84 of the housing 30 in an open configuration, and FIG. 8 is an exploded perspective view thereof. As shown in FIGS. 6-8, the housing 30 and bottle cavity 32 for holding the spray bottle 40 can be formed in a variety of shapes and structures, which should be considered within the scope of the present invention. In this embodiment, the housing 30 includes the nozzle cover 84 mounted on a pivot bracket 86 that is mounted on the elongate handle member 22 above the bottle cavity 32. The nozzle cover 84 covers the spray outlet 59 of the spray bottle 40, including the spray outlet 59. In this manner, the spray bottle 40 is prevented from accidental spraying when the nozzle cover 84 is pivoted downwardly to cover the spray outlet 59.

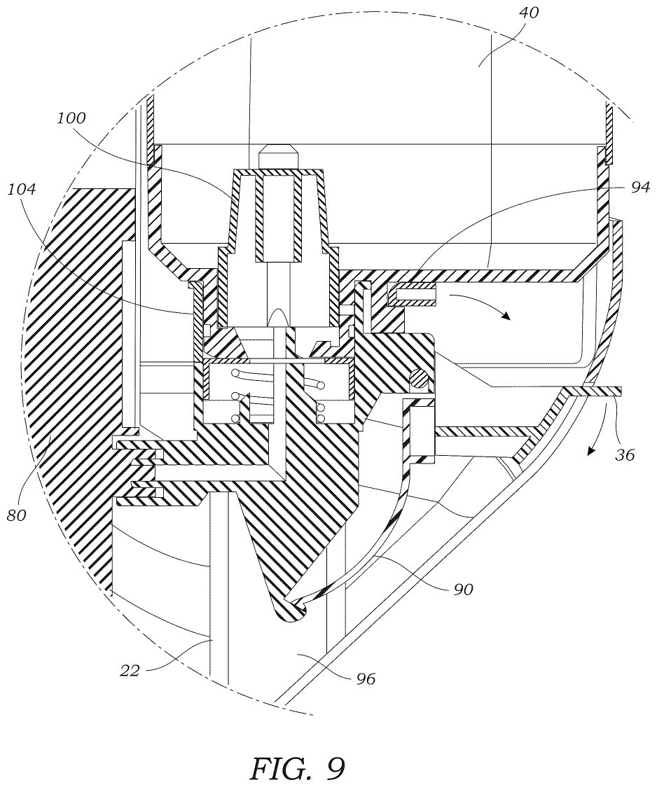

FIG. 9 is an up-close sectional view of the detachment mechanism 36 of the housing 30. As shown in FIG. 9, in this embodiment, the detachment mechanism 36 is in the form of a release latch that contacts a tension arm 90, such that when pressed downwardly, the release latch 98 causes the tension arm 90 to flex and release the spray bottle 40 from the bottle cavity 32. The tension arm 90 functions as an internal spring, and engages with a spray bottle latch 94 to disengage the spray bottle 40.

Also shown in FIG. 9 is a second embodiment of the spray bottle valve 100, and further a liquid conduit 96 for transferring the cleaning solution into the mop 20.

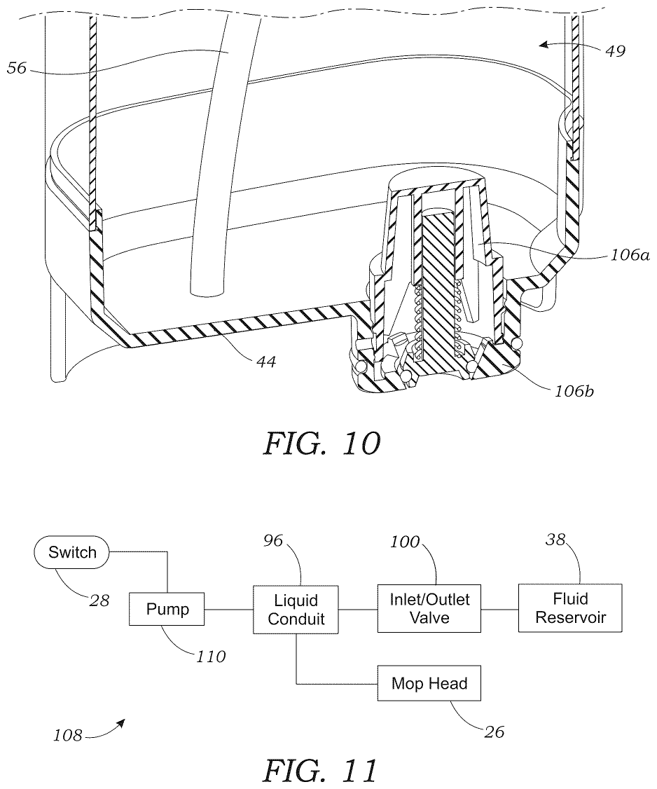

FIG. 10 is an up-close sectional view of the valve 100 of the spray bottle 40. As shown in FIG. 10, the cleaning system 10 may include a two-part quick-connect coupling having a first coupling member in the form of the valve 100 and a second coupling member 104 (in the mop 20), each defining a respective internal passageway 106a and 106b. The passageways 106 are placed in fluid communication when the coupling members 100 and 104 are engaged, permitting fluid flow therethrough. Each coupling member 100 and 104 includes an internal self-sealing valve (such as, for example, a spring-biased poppet or ball valve) that automatically closes when the coupling members 100 and 104 are disengaged, thereby preventing leakage or backflow. The quick-connect coupling is configured such that, when engaged together, the internal passageways 106 are placed in fluid communication to permit fluid flow therethrough. When the quick-connect coupling is disengaged, the internal self-sealing valve elements 100 and 104 automatically close to prevent fluid leakage. When the bottle 40 is detached, the self-sealing valve automatically closes to prevent leakage, enabling clean and safe handling of the spray bottle 40. In various embodiments, the valve 100 may be any suitable form of valve for transferring the cleaning solution to the mop 20, as determined by one skilled in the art.

FIG. 11 is a block diagram illustrating a pump system 108 of the cleaning system 10. As shown in FIG. 11, the pump system 108 includes a pump 110 with the switch 28, the switch 28 typically being in the top handle 24 of the mop 20, but other locations may be possible. The pump 110 is in communication with a liquid conduit 96, e.g., a tubular conduit that extends from the switch to the valve 50 or 100, and also from the valve 50/100 to the cleaning implement 26. In some embodiments, the switch is in the form of the trigger handle 28 (FIG. 1), but any form of switch may be included (button, switch, twist-mechanism, etc., or any form of switch). The switch 28 may include a small piston-and-cylinder assembly (not shown), such that squeezing the trigger handle 28 pushes the piston forward, pressurizing a small volume of air or fluid. In some embodiments, the switch 28 includes an electric micro-pump powered by a small battery (not shown).

Furthermore, the spray bottle 40 connects to the liquid conduit 96 through a one-way check valve, as described above. The pressurized liquid travels through the liquid conduit 96 (e.g., a narrow plastic tube running down the handle 24 to one or more nozzles near the mop head 26), which atomize the liquid into a spray. In a resting state where the switch 28 is not actuated, the liquid conduit 96 is filled with cleaning solution drawn from the reservoir 49. Pressing the trigger 28 pushes the piston forward, closing the inlet check valve and opening the outlet valve, wherein the cleaning fluid is forced through the outlet tube toward the spray outlet 58 or the cleaning implement 26. When the trigger 28 is released, a return spring retracts the piston, creating a vacuum. The outlet valve closes, the inlet valve opens, and a small amount of solution from the bottle refills the liquid conduit 96 for the next spray.

While the drawings illustrate two examples of the spray bottle 40, it should be understood that any shape of bottle may be used, of varying sizes and having varying indentations, etc., as long as it can fit within the bottle cavity 32 of the mop 20 for use.

Overall, the dual-function design allows the user to clean vertical surfaces (countertops, windows, shelves) without carrying a separate spray bottle, improving convenience and reducing the need for multiple cleaning products.

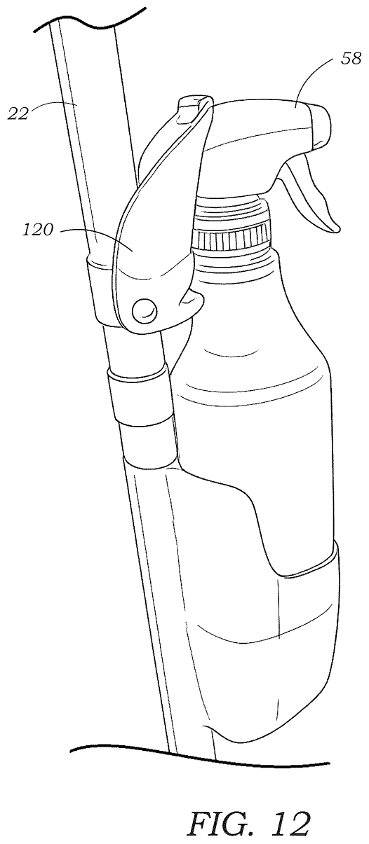

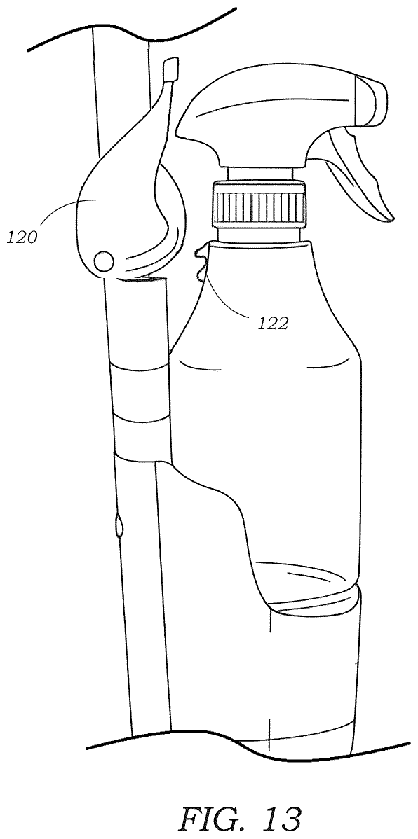

FIG. 12 is a perspective view of a 120 locking mechanism according to one embodiment of the present invention and showing the locking mechanism 120 in a locked position, and FIG. 13 is a side elevation view thereof, showing the locking mechanism 120 in an unlocked position to allow the spray bottle 40 to be removed from the housing 30. As shown in FIGS. 12-13, in this embodiment, the locking mechanism 120 is in the form of a lever that is pivotally mounted on the elongate handle member 22 so that it is adjacent the top of the spray bottle 40 when the spray bottle 40 is in the housing 30. The locking mechanism 120 engages with the spray pump mechanism 58 in the locked position (FIG. 12), and can be pivoted upwardly to release the bottle 40 (FIG. 13). In some embodiment, the spray bottle 40 has an engagement structure 122 (e.g., grooves, cutouts, pins, rails, etc.) that engages the lever 120. This functions as an alternative to a button release mechanism for releasing the bottle 40.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A cleaning system comprising:
an elongate handle member extending from a top handle to a cleaning implement;
a housing formed on the elongate handle member between the top handle and the cleaning implement, the housing including a bottle cavity having a connecting surface for engaging a spray bottle;
a detachment mechanism for disengaging the connecting surface from the spray bottle, enabling the spray bottle to be used independently;
wherein the spray bottle comprises a liquid storage compartment, a spray pump mechanism, and a valve for transferring liquid from the liquid storage compartment to the cleaning implement; and
wherein the spray pump mechanism includes a pump actuator lever that operatively controls a pump for spraying liquid from a spray outlet.

2. The cleaning system of claim 1, wherein the detachment mechanism is a release lever that allows for quick detachment of the spray bottle.

3. The cleaning system of claim 1, wherein the spray pump mechanism is attached to an elongate stem tube.

4. The cleaning system of claim 1, wherein the spray bottle includes a refill cartridge for injecting cleaning product into the liquid storage compartment.

5. The cleaning system of claim 1, wherein the housing includes a nozzle cover that prevents accidental spraying when pivoted to cover the spray outlet.

6. The cleaning system of claim 1, wherein the valve is tubular in construction and adapted for engagement with the connecting surface of the mop.

7. The cleaning system of claim 1, further comprising:
a two-part quick-connect coupling having a first coupling member in the spray bottle and a second coupling member in the mop, each defining a respective internal passageway;
wherein the passageways are in fluid communication when the coupling members are engaged, permitting fluid flow therethrough; and
wherein each coupling member includes an internal self-sealing valve that automatically closes when the coupling members are disengaged, thereby preventing leakage or backflow.

8. A spray bottle for use with a mop, the spray bottle comprising:
a liquid storage compartment defined by an upwardly extending sidewall extending from a base to a neck;
a spray pump mechanism attached to the neck, the spray pump mechanism including an elongate stem tube extending into the liquid storage compartment; and
a valve located at the base for engaging with the mop, facilitating the transfer of liquid from the liquid storage compartment to the mop.

9. The spray bottle of claim 8, wherein the base includes a downwardly extending wall with a front opening and a back opening, adapted for engagement with the connecting surface of the mop.

10. The spray bottle of claim 8, wherein the spray pump mechanism is removably attached to the neck via a threaded engagement.
